(19) United States
(12) Patent Application Publication
(10) Pub. No.: US 2005/0056598 A1
(43) Pub. Date: Mar. 17, 2005

(54) Method for treating recalcitrant organic compounds

(76) Inventors: Ajit K. Chowdhury, Madison, WI (US); Larry Kinsman, Madison, WI (US); Sarah K. Wilk, Green Bay, WI (US)

Correspondence Address: QUARLES & BRADY LLP, FIRSTAR PLAZA, ONE SOUTH PINCKNEY STREET, P.O BOX 2113 SUITE 600, MADISON, WI, 53701-2113, US

(21) Appl. No.: 10/859,803

(22) Filed: Jun. 3, 2004

Related U.S. Application Data
(60) Provisional application No. 60/476,562, filed on Jun. 6, 2003.

(51) Int. Cl. C02F 1/70

(52) U.S. Cl. 210/757; 210/758

(57) ABSTRACT

A method for decontaminating a recalcitrant organic compound (ROC)-contaminated matrix is disclosed. The method involves pre-treating the matrix with an oxidizing agent to release the ROC from the matrix and then exposing the released ROC to a reducing agent to convert the ROC to a non-toxic substance.

### CROSS-REFERENCE TO RELATED APPLICATIONS

This application claims the benefit of U.S. Provisional Patent Application No. 60/476,562, filed Jun. 6, 2003, incorporated by reference as if set forth herein in its entirety.

### STATEMENT REGARDING FEDERALLY SPONSORED RESEARCH OR DEVELOPMENT

Not applicable.

### BACKGROUND OF THE INVENTION

Processes are known for destroying low molecular weight organochlorine solvents such as trichloroethylene, perchlorethylene, etc. in matrices (including, but not limited to soil, water, sediment, industrial wastes, sludge, and agricultural waste) by chemical oxidation, by reductive dechlorination, or by biological treatment with hydrogen release compounds. Known chemical oxidation methods include treatment with Fenton's reagent (hydrogen peroxide+acidified ferrous sulfate), permanganates, persulfates, and the like. Known reductive dechlorination methods use, e.g., elemental (zero-valent) iron. Hydrogen release compounds useful in a biological treatment method include lactates and molasses. These approaches often require multiple applications of the treatment chemistry because of the slow diffusion of the adsorbed/absorbed contaminants from inner cores of the waste matrices.

Moreover, these processes are not very effective in treating or destroying higher molecular weight recalcitrant organic compounds (ROCs), which remain a persistent challenge in the art of environmental remediation. High molecular weight organohalogen compounds—organochlorine pesticides and herbicides (Lindane, toxaphene, atrazine, DDT, etc.), polychlorinated biphenyls (PCBs), haloaromatics (benzene hexachloride, etc.) and nitramine munitions (cyclotrimethylenetrinitramine [RDX], cyclotetramethylenetetranitramine [HMX], nitroaromatics, etc.)—are characterized by resistance to biodegradation and to common organic waste treatment processes such as chemical oxidation at ambient temperatures and pressures.

U.S. Pat. Nos. 6,207,073 and 6,039,882 disclose processes for solubilizing organochlorine compounds in alcohol and then dechlorinating the compounds with zero-valent iron and iron sulfide. U.S. Pat. No. 5,197,823 discloses PCB dechlorination by wetting the soil and adding elemental zinc. U.S. Pat. No. 3,640,821 describes using elemental zinc at pH<4 to reductively degrade halogenated pesticides. U.S. Pat. Nos. 6,382,537; 6,197,187; 5,411,664; 5,185,488 and 4,950,833 also disclose various methods for reductive dehalogenation of ROCs.

Ress describes a process for chemical dechlorination of chlorinated pesticides using amended zero-valent iron, which process generally requires days to months of reaction time to accomplish substantial reductions. See, Press Release, “Simple Iron Treatment Inexpensively Removes Pesticides from Contaminated Soil,” University of Nebraska (Lincoln) News Service (Feb. 16, 2000).

Alternative effective and cost-effective processes for destroying high molecular weight ROCs are still sought in the art.

### BRIEF SUMMARY OF THE INVENTION

The present invention is summarized in that the inventors have appreciated that ROCs, especially ROCs having greater than about 3 carbons, and particular those having branched structures or ring structures, are substantially unavailable for dehalogenation when present in common matrices, but are more readily converted into non-toxic substances if the matrix is pre-treated with an oxidizing agent, preferably a strong oxidizing agent, to release the ROCs from the matrix before dehalogenation. The present invention is not limited to organohalogen compounds and applies to all ROCs for which the conventional decontamination method involves treating the ROC with a reducing agent. The pre-treatment step of the method significantly reduces the time required to destroy the ROC.

In one aspect, the present invention relates to a method for decontaminating a ROC-contaminated matrix by pre-treating the matrix with an oxidizing agent to release the ROC from the matrix and then exposing the released ROC to a reducing agent to convert the ROC into a non-toxic substance. Any conventional agent and process for reducing the ROC can be employed in the method. The method is effective for all intended ROCs without regard to molecular weight but particularly for organohalogen compounds such as organochlorine compounds.

The pre-treatment step is a liquid-based step in that a liquid must be present along with the matrix to capture the ROC released from the matrix. The amount of liquid should be sufficient to capture at least 50%, preferably at least 90% of the ROC released from the matrix. A skilled artisan can readily determine the sufficient amount of a liquid based on the type and level of the contamination. Typically, a small amount of liquid enough to wet or moisturize the matrix is sufficient for the purpose of the present invention. Preferably, the liquid is water or an aqueous solution. For a wetted/moisturized matrix or an oxidizing agent that is provided in a liquid, the oxidizing agent can be added to the matrix directly. Otherwise, a dried matrix should be wetted (e.g., moisturized) before an oxidizing agent is added. Following the pre-treatment step, the whole liquid-matrix mixture can be treated with a reducing agent. Alternatively, if sufficient liquid is present so that it is relatively easy to separate the liquid from the matrix, the liquid containing the ROC can be separated from the matrix and treated with the reducing agent.

Pre-treatment can take place in situ, ex situ, or in a combination in situlex situ process. Suitable oxidizing agents for the pre-treatment step include but are not limited to Fenton's reagent, hydrogen peroxide (such as that in a solution), other peroxides (e.g., calcium peroxide, magnesium peroxide, and sodium percarbonate), permanganates (e.g., sodium permanganate and potassium permanganate), persulfates (e.g., sodium persulfate and ammonium persulfate), perchlorates, and the like.

Following pretreatment in accord with the method, any known conventional process for reducing and destroying the ROC can proceed. For organohalogen compounds, the process involves chemical dehalogenation. For example, the dehalogenation step can include contact with elemental iron or elemental zinc, with or without enhancement additives such as acidic aluminum salts (e.g., aluminum chloride or sulfate), iron (ferrous and ferric) salts (e.g., iron sulfates or chlorides), and carboxylic acids (e.g., acetic acid, lactic acid, and citric acid), and the like.

Optionally and as needed, a polishing treatment step can be employed after the reducing agent treatment step to further destroy the remnant contaminants in the matrix and associated liquid such as water. Examples of polishing treatments include but are not limited to chemical or biological dehalogenation, aerobic biodegradation, oxidation, activated carbon adsorption, natural attenuation, and the like. Additionally, depending on the waste matrix, the pre-treatment step (oxidation step) may be preceded by preliminary pretreatment incorporating size reduction and/or contact of the matrix with a pH controlled aqueous media including acid, alkali, or surfactants.

In one embodiment of the present invention, the waste/soil matrix present in a subsurface setting is first oxidized in situ by injection of oxidizing agents via injection wells to facilitate release of the organic compounds into groundwater. The groundwater containing the released organic compounds is then pumped via recovery wells to maintain hydraulic control of the released organics and to facilitate above ground dechlorination treatment of the organics. The treated groundwater may be recycled back into the subsurface soil along with appropriate quantities of oxidizing agents. For contaminated unsaturated soil, an oxidizing solution is percolated through the vadose zone and the organics released from the soil captured in the groundwater is then pumped for above ground treatment. This approach will significantly enhance traditional “pump and treat” process resulting in expeditious and efficient site closure.

In another embodiment of the present invention, the adsorbed/absorbed ROCs are released from the soil by activation of the soil matrix by chemical oxidation and the released ROCs are carried by the groundwater into a downstream reaction wall containing the dechlorination additives so that any groundwater going past the reaction wall is substantially free of ROCs. By substantially free of ROCs, we mean that the ROC level is reduced by at least 50%, preferably by at least 90%.

### BRIEF DESCRIPTION OF THE SEVERAL VIEWS OF THE DRAWINGS

Not applicable.

### DETAILED DESCRIPTION OF A PREFERRED EMBODIMENT

A pesticide-contaminated soil was treated with Fenton's reagent (hydrogen peroxide+acidified ferrous sulfate), zero-valent iron, and with enhanced zero-valent iron chemistry according to the present invention wherein the test soil was first treated with Fenton's reagent and then reacted with zero-valent iron along with aluminum sulfate and acetic acid. The results of the testing presented below show significantly higher destruction of the organochlorine compounds with enhanced zero-valent iron in comparison to the treatment effectiveness with other additives.

| | | TREATMENT CHEMISTRY | | |
|---|---|---|---|---|
| | | | | ENHANCED |
| ANALYTE | UN- | | ZERO- | ZERO- |
| (Concentrations | TREATED | FENTON'S | VALENT | VALENT |
| in mg/kg) | SOIL | REAGENT | IRON | IRON |
| 4,4′-DDD | 980 | 1,400 | 1,200 | 230 |
| 4,4′-DDE | 460 | <350 | <280 | 150 |
| 4,4′-DDT | 27,000 | 14,000 | 13,000 | 5,600 |
| Aldrin | 605 | 1,200 | 480 | 210 |
| alpha-BHC | 13,000 | 13,000 | 7,700 | 4,600 |
| alpha- | 305 | <180 | 240 | 100 |
| Chlordane | | | | |
| beta-BHC | 1,035 | 1,900 | 1,600 | 600 |
| delta-BHC | 3,850 | 3,700 | 2,400 | 1,300 |
| Dieldrin | 620 | 940 | 470 | 170 |
| gamma-BHC | 12,400 | 12,000 | 4,500 | 4,000 |
| (Lindane) | | | | |
| gamma- | 440 | 650 | 230 | <73 |
| Chlordane | | | | |
| Heptachlor | 850 | 1,000 | <140 | 310 |
| Toxaphene | 51,000 | 51,000 | 43,000 | 18,000 |
| Total | 112,545 | 101,320 | 75,240 | 35,343 |
| % Reduction | — | 10 | 33.2 | 68.6 |

A groundwater sample contaminated with organochlorine pesticides was treated with amended zero-valent iron using iron with aluminum sulfate and acetic acid and with enhanced zero-valent iron, in accordance with the present invention, incorporating initial treatment with Fenton's reagent followed by treatment with amended zero-valent iron. As presented below, the results of the treatment testing show significantly higher destruction of organochlorine pesticides when treated according to the present invention.

| | | TREATMENT CHEMISTRY | |
|---|---|---|---|
| | | AMENDED | ENHANCED |
| | UNTREATED | ZERO- | ZERO- |
| ANALYTE | GROUND- | VALENT | VALENT |
| (Concentrations in μg/kg) | WATER | IRON | IRON |
| 4,4′-DDD | 61 | 30 | 3.1 |
| 4,4′-DDE | 15 | 19 | 2.7 |
| 4,4′-DDT | 117 | 43 | 8.4 |
| Aldrin | 9 | 13 | 2 |
| alpha-BHC | <1.99 | <0.089 | 0.4 |
| alpha-Chlordane | 121 | 55 | 11 |
| beta-BHC | <2.1 | <0.095 | <0.27 |
| delta-BHC | <2.2 | <0.23 | <0.28 |
| Dieldrin | <4.9 | 15 | <0.62 |
| Endosulfan I | 420 | 160 | 12 |
| Endosulfan II | 125 | 48 | 3.7 |
| Endosulfan sulfate | 11.2 | <0.86 | <0.62 |
| Endrin | 13.4 | 8.8 | <0.45 |
| Endrin aldehyde | <4.2 | <0.19 | <0.53 |
| Endrin ketone | 5.2 | <0.17 | <0.47 |
| gamma-BHC (Lindane) | 26 | <0.98 | 1.7 |
| gamma-Chlordane | 175 | 70 | 16 |
| Heptachlor | 16 | 8.4 | 2 |
| Heptachlor epoxide | <2.4 | <1.5 | 0.57 |
| Methoxychlor | 795 | 240 | 22 |
| Toxaphene | 249 | <8.1 | <23 |
| Total | 2,177 | 722 | 112 |
| % Reduction | — | 67 | 95 |

The present invention is not intended to be limited to the foregoing but rather to encompass all such variations and modifications as come within the scope of the appended claims.

1. A method for decontaminating a recalcitrant organic compound-contaminated matrix wherein conventional decontamination for the compound involves treating the matrix with a reducing agent, the method comprising the steps of:
exposing the matrix to an oxidizing agent to release the recalcitrant organic compound into a liquid; and
exposing the released recalcitrant organic compound to a reducing agent to reduce the compound.

2. The method of claim 1, wherein the recalcitrant organic compound has three or more carbons.

3. The method of claim 1, wherein the recalcitrant organic compound has at least one of a branched structure or a ring structure.

4. The method of claim 1, wherein the recalcitrant organic compound is an organohalogen compound.

5. The method of claim 4, wherein the reducing agent comprises a chemical dehalogenation agent.

6. The method of claim 4, wherein the organohalogen compound is an organochlorine compound.

7. The method of claim 1, wherein the recalcitrant organic compound is selected from the group consisting of Lindane, toxaphene, atrazine, DDT, a polychlorinated biphenyl, a haloaromatics, and a nitramine munition.

8. The method of claim 1, wherein the matrix is selected from the group consisting of soil, water, sediment, industrial waste, sludge, and agricultural waste.

9. The method of claim 1, wherein the matrix is exposed to the oxidizing agent in situ.

10. The method of claim 1, wherein the matrix is exposed to the oxidizing agent ex situ.

11. The method of claim 1, wherein the oxidizing agent is selected from the group consisting of Fenton's reagent, a peroxide, a permanganate, a persulfate, and a perchlorate.

12. The method of claim 1, wherein the reducing agent is selected from the group consisting of elemental iron and elemental zinc.

13. The method of claim 1, wherein the reducing agent is supplemented with an enhancement additive selected from the group consisting of an acidic aluminum salt, an iron salt, and a carboxylic acid.

14. The method of claim 1, further comprising the step of providing polishing treatment to the matrix and associated liquid.

15. The method of claim 14, wherein the polishing treatment is selected from the group consisting of chemical reduction, biological reduction, oxidation, aerobic biodegradation, activated carbon adsorption, and natural attenuation.
